(19) United States
(12) Patent Application Publication
(10) Pub. No.: US 2026/0302701 A1
(43) Pub. Date: Oct. 1, 2026

(54) ELECTRICAL OUTLET TERMINAL CONFIGURATION WITH A PLURALITY OF WIRING POINTS

(71) Applicant: Zhejiang Yuchuang Electronic Technology Co., Ltd., Wenzhou (CN)

(72) Inventors: Yangen CHEN, Wenzhou (CN); Jingzheng CHEN, Wenzhou (CN)

(21) Appl. No.: 19/416,705

(22) Filed: Dec. 11, 2025

(30) Foreign Application Priority Data
Mar. 28, 2025 (CN) 202520560956.0

(51) Int. Cl. H01R 25/00; H01R 4/38; H01R 13/506

(52) U.S. Cl. CPC H01R 25/006; H01R 4/38; H01R 13/506

(57) ABSTRACT

An electrical outlet terminal configuration with a plurality of wiring points includes a main housing, where the main housing is provided with mounting grooves recessed inward from an outer surface of the main housing, and the terminals are mounted within the mounting grooves; a flippable protective cover is disposed for each of the mounting grooves, and a middle partition plate is disposed below the protective cover to partition a space into two terminals; and a lower side end of the main housing is provided with wiring holes aligned with the terminals, each of the terminals is aligned downward with two of the wiring holes, a wire is inserted into the terminal via one of the wiring holes, and the wire is clamped and conductively connected by a first conductive clamping mechanism of the terminal. In the present disclosure, more wires can be connected to achieve connection of more electrical loads.

### CROSS-REFERENCE TO RELATED APPLICATIONS

The present application claims priority to Chinese Patent Application No. 202520560956.0, filed Mar. 28, 2025, the entire disclosure of which is incorporated herein by reference.

### TECHNICAL FIELD

The present disclosure relates to electrical outlet products, and in particular to an electrical outlet terminal configuration with protective covers and a plurality of wiring points.

### BACKGROUND

Invention Patent Application No. ZL201420206920.4 discloses a switch outlet combo, and in particular to an improved structure for terminals of a switch outlet combo. Primarily, the switch outlet combo is provided with a wiring accessory accommodating cavity, a wiring frame and a screw are respectively disposed in the wiring accessory accommodating cavity, the wiring frame is positioned within the accommodating cavity, and an upper part of the wiring frame is provided with internal threads; and a wire-pressing plate is further disposed within the wiring frame, a top of the screw is positioned at the upper opening of the accommodating cavity, while a bottom of the screw is rotated into the wiring frame through the internal threads of the wiring frame and extends towards the wire-pressing plate, and a wire-pressing cavity is formed by a gap existing between the wire-pressing plate and an inner wall of the wiring frame. This type of switch outlet combo has only two terminals at a lower portion, thereby failing to connect additional wires or connect more electrical loads. Consequently, the switch outlet combo is generally limited to functioning as an ordinary outlet, solely intended for routine plug-in power supply applications for external electrical appliances.

### SUMMARY

In view of the deficiencies in the prior art, the technical problem to be solved by the present disclosure is to provide an electrical outlet terminal configuration with a plurality of wiring points, which simultaneously achieves both effective protection of the terminals and convenience for wiring operation, and also achieves expansion of more wiring points.

To this end, the present disclosure is implemented by the following technical solution:

An electrical outlet terminal configuration with a plurality of wiring points includes a main housing provided with terminals, where the main housing is provided with mounting grooves recessed inward from an outer surface of the main housing, and the terminals are mounted within the mounting grooves; a flippable protective cover is disposed for each of the mounting grooves, an upper portion of the protective cover is pivotally connected to the main housing, a mutually engageable force-releasable snap-fit mechanism is disposed for the protective cover and the main housing, and the snap-fit mechanism is engaged when the protective cover is closed to cover the mounting groove; and a middle partition plate is disposed below the protective cover to partition a space into a plurality of terminals, a lower side end of the main housing is provided with wiring holes aligned with the terminals, each of the terminals is aligned downward with a plurality of the wiring holes, a wire is inserted into the terminal via one of the wiring holes, and the wire is clamped and conductively connected by a first conductive clamping mechanism of the terminal.

Preferably, each of the protective covers includes a panel, side edges, and a lower edge, where the side edges and the lower edge are perpendicular to the panel, the lower edge is provided with notch slots, two of the notch slots are disposed below each terminal, two prongs of a U-shaped blade are inserted into the terminal through the corresponding notch slots, and the prongs are clamped and conductively connected by a second conductive clamping mechanism of the terminal.

Preferably, the space within each of the protective covers is partitioned by a middle partition plate into two terminals, and each of the terminals includes a screw with a cap, a wiring end plate, and a lower clamping plate; each of the mounting grooves is partitioned into wiring grooves, the wiring end plate is mounted on stepped surfaces of each of the wiring grooves, the lower clamping plate is positioned within the wiring groove and beneath the wiring end plate, and the screw extends through threaded holes of the wiring end plate and the lower clamping plate to form a threaded connection fit; the first conductive clamping mechanism includes the screw, the wiring end plate, and the lower clamping plate, and side walls of the wiring groove restrict rotation of the wiring end plate and the lower clamping plate in a blocking manner; each of the terminals corresponds to two of the wiring holes, and the wiring holes directly face the space between the lower clamping plate and the wiring end plate; and after a wire is inserted through one wiring hole into the space between the lower clamping plate and the wiring end plate, the screw is rotated to cause the lower clamping plate to ascend and clamp the wire against the wiring end plate, thereby establishing a conductive connection.

Preferably, two of the wiring holes are disposed below each of the terminals.

Preferably, each of the terminals includes a screw with a cap, a wiring end plate, and a lower clamping plate, and each of the terminals corresponds to two of the notch slots; the mounting groove is partitioned into wiring grooves, the wiring end plate is mounted on stepped

surfaces of each of the wiring grooves, the lower clamping plate is positioned within the wiring groove and beneath the wiring end plate, and the screw extends through threaded holes of the wiring end plate and the lower clamping plate to form a threaded connection fit; the screw and the wiring end plate constitute a second conductive clamping mechanism, and side walls of the wiring groove restrict rotation of the wiring end plate and the lower clamping plate in a blocking manner; and after a U-shaped blade is inserted through the notch slots into the space between the cap and the wiring end plate, the screw is rotated to cause the cap to descend and clamp the U-shaped blade against the wiring end plate, thereby establishing a conductive connection.

Preferably, an inner side of the lower edge of the protective cover is provided with a triangular latching tooth, and a lower side of the middle partition plate of the main housing is provided with a latching groove matching the latching tooth; and when the protective cover is flipped down and secured onto the terminal, the latching tooth is snap-fitted into the latching groove along a triangular mating surface.

Preferably, a lower partition plate of each of the wiring grooves extends laterally to form an elastic arc-shaped barrier strip, and a root portion of the elastic arc-shaped barrier strip is fixed to either the middle partition plate or the main housing outside the wiring groove.

Preferably, an inner wall of each of the protective covers is provided with circular lateral recesses matching the terminals at positions corresponding to the terminals.

Preferably, each of the protective covers is provided with pivot shafts on both sides, the main housing on both sides of each of the mounting grooves is provided with pivot connecting grooves, and the pivot shafts are inserted into the pivot connecting grooves.

By employing the above technical solution, the present disclosure has the following beneficial effects:
1. The flippable protective covers used in the present disclosure achieve effective coverage of the terminals, and the force-releasable snap-fit mechanisms are configured to maintain the flippable protective covers in a covered state, thereby providing dust-proof, contamination-proof, and accidental contact-proof functions. The protective covers are easy to open, thus achieving convenience for wiring operation.
2. Each of the protective covers overlays a plurality of terminals, and a plurality of wiring holes are correspondingly disposed for each of the terminals to expand more wiring channels. The first conductive clamping mechanism and the second conductive clamping mechanism are respectively formed on top and bottom sides of the wiring end plate, thereby achieving connections for more wires and electrical loads. This configuration facilitates integrated connection retrofitting of old circuits through implementation of the electrical outlet of the present disclosure.
3. A bottom of the main housing is provided with wiring holes, a lower side of each of the protective covers is provided with notch slots, and the wiring holes and the notch slots are combined to form a plurality of wiring channels, thereby achieving the expansibility of wiring channels. Moreover, a notch slot wiring mode of the protective cover adapts to diversified wire types and specifications.

### BRIEF DESCRIPTION OF THE DRAWINGS

The present disclosure has the following figures:

FIG. 1 is a structural plan of an electrical outlet provided by the present disclosure, where an electrical outlet terminal configuration is disposed.

FIG. 2 is a rear view of FIG. 1.

FIG. 3 is a perspective structural view of FIG. 1.

FIG. 4 is a perspective structural view of FIG. 3 with a terminal removed from the electrical outlet.

FIG. 5 is a structural view of a terminal.

### DETAILED DESCRIPTIONS OF THE EMBODIMENTS

To further elaborate on the technical means employed by the present disclosure to achieve the intended objectives and the resultant efficacy, the specific implementations, structures, features, and functions of the present disclosure will be described below in detail in combination with the drawings and preferred embodiments.

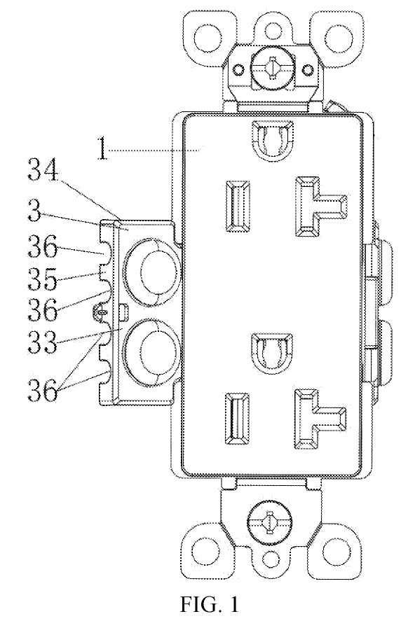

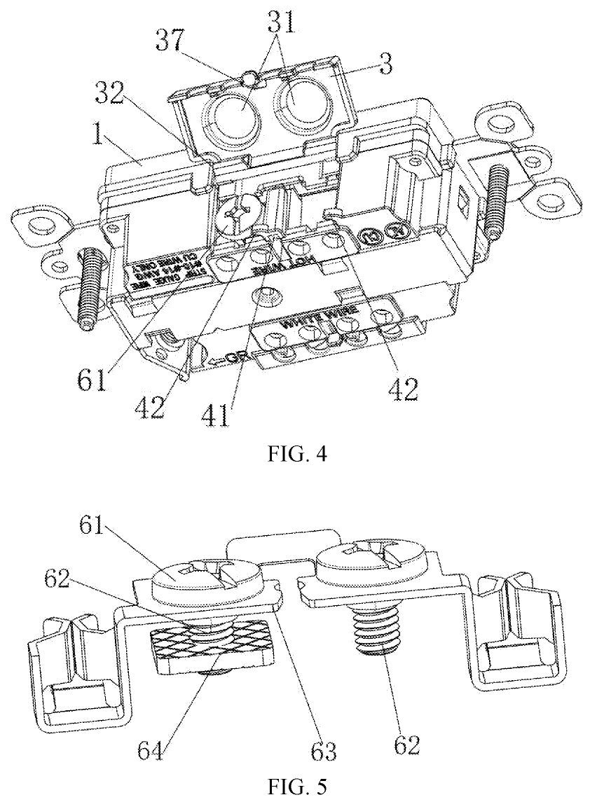

Referring to FIGS. 1-5, an electrical outlet terminal configuration with a plurality of wiring points provided in an embodiment of the present disclosure includes a main housing 1 provided with terminals, where the main housing 1 is provided with mounting grooves 2 recessed inward from an outer surface of the main housing 1, and the terminals are mounted within the mounting grooves 2; a flippable protective cover 3 is disposed for each of the mounting grooves 2, an upper portion of the protective cover 3 is pivotally connected to the main housing 1, a mutually engageable force-releasable snap-fit mechanism is disposed for the protective cover 3 and the main housing 1, and the snap-fit mechanism is engaged when the protective cover 3 is closed to cover the mounting groove 2; and a middle partition plate 4 is disposed below the protective cover 3 to partition a space into two terminals, an inner wall of the protective cover 3 is provided with circular lateral recesses 31 matching the terminals at positions corresponding to the terminals, a lower side end of the main housing 1 is provided with wiring holes 5 aligned with the terminals, two of the wiring holes 5 are disposed below

each of the terminals, a wire is inserted into the terminal via one of the wiring holes 5, and the wire is clamped and conductively connected by a first conductive clamping mechanism of the terminal. The protective cover 3 is provided with pivot shafts 32 on both sides, the main housing on both sides of each of the mounting grooves 2 is provided with pivot connecting grooves, and the pivot shafts 32 are inserted into the pivot connecting grooves.

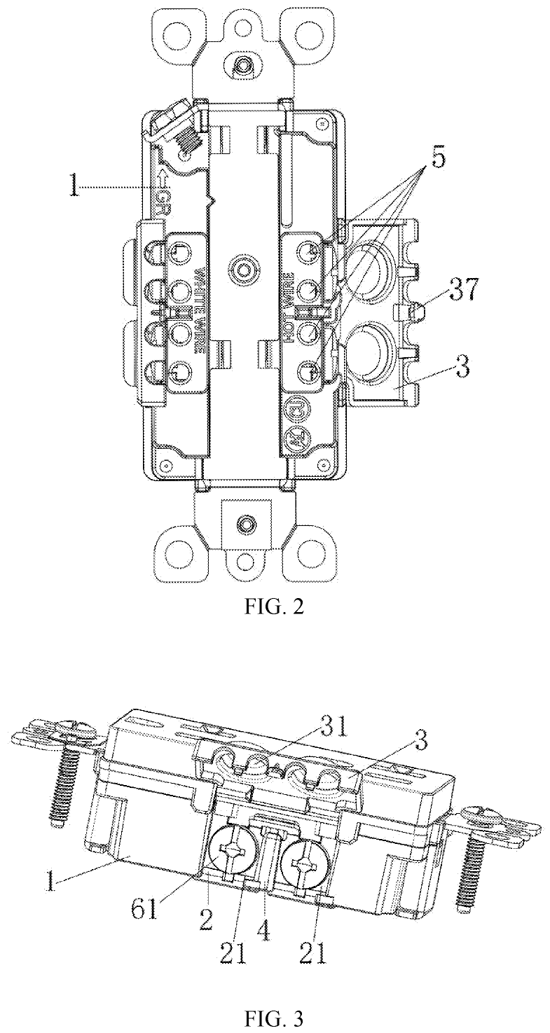

Referring to FIGS. 2, 3 and 4, to form wiring channels of more types, each of the protective covers 3 includes a panel 33, side edges 34, and a lower edge 35, where the side edges 34 and the lower edge 35 are perpendicular to the panel 33, the lower edge 35 is provided with notch slots 36, two of the notch slots 36 are disposed below each terminal, two prongs of a U-shaped blade are inserted into the terminal through the corresponding notch slots 36, and the prongs are clamped and conductively connected by a second conductive clamping mechanism of the terminal. This wiring mode provides a large adjustable space, thus facilitating operation and adjustment. Particularly when a wire is difficult to insert, the protective cover 3 is directly opened for insertion and connection operation.

Referring to FIGS. 3, 4 and 5, to achieve clamping and connection of the upper end and the lower end of the terminal, the space within each of the protective covers 3 is partitioned by a middle partition plate 4 into two terminals, and each of the terminals includes a screw 62 with a cap 61, a wiring end plate 63, and a lower clamping plate 64; the mounting groove 2 is partitioned into wiring grooves 21, the wiring end plate 63 is mounted on stepped surfaces of each of the wiring grooves 21, the lower clamping plate 64 is positioned within the wiring groove 21 and beneath the wiring end plate 63, and the screw 62 extends through threaded holes of the wiring end plate 63 and the lower clamping plate 64 to form a threaded connection fit; and the first conductive clamping mechanism includes the screw 62, the wiring end plate 63, and the lower clamping plate 64, and side walls of the wiring groove 21 restrict rotation of the wiring end plate 63 and the lower clamping plate 64 in a blocking manner. When the screw 62 is rotated, rotation of the lower clamping plate 64 is restricted by the side walls of the wiring groove 21, the lower clamping plate 64 is moved upward and downward along threads of the screw 62, and the cap 61 of the screw 62 is moved downward to achieve clamping against the wiring end plate 63. In this embodiment, each of the terminals corresponds to two of the wiring holes 5, and the wiring holes 5 directly face the space between the lower clamping plate 64 and the wiring end plate 63; and after a wire is inserted through one wiring hole 5 into the space between the lower clamping plate 64 and the wiring end plate 63, the screw 62 is rotated to cause the lower clamping plate 64 to ascend and clamp the wire against the wiring end plate 63, thereby establishing a conductive connection. Moreover, each of the terminals corresponds to two of the notch slots 36; each of the mounting grooves 2 is partitioned into wiring grooves 21, the wiring end plate 63 is mounted on stepped surfaces of each of the wiring grooves 21, the lower clamping plate 64 is positioned within the wiring groove 21 and beneath the wiring end plate 63, and the screw 62 extends through threaded holes of the wiring end plate 63 and the lower clamping plate 64 to form a threaded connection fit; the screw 62 and the wiring end plate 63 constitute a second conductive clamping mechanism, and the side walls of the wiring groove 21 restrict rotation of the wiring end plate 63 and the lower clamping plate 64 in a blocking manner; and after a U-shaped blade is inserted through the notch slots 36 into the space between the cap 61 and the wiring end plate 63, the screw 62 is rotated to cause the cap 61 to descend and clamp the U-shaped blade against the wiring end plate 63, thereby establishing a conductive connection.

Referring to FIGS. 2, 3 and 4, to enable the protective cover 3 to be snap-fitted onto the main housing 1, an inner side of the lower edge of the protective cover 3 is provided with a triangular latching tooth 37, and a lower side of the middle partition plate 4 of the main housing 1 is provided with a latching groove 41 matching the latching tooth 37; and when the protective cover 3 is flipped down and secured onto the terminal, the latching tooth 37 is snap-fitted into the latching groove 41 along a triangular mating surface. A lower partition plate of each of the wiring grooves 21 extends laterally to form an elastic arc-shaped barrier strip 42 which is made of the same slightly elastic plastic as the main housing 1 and formed as an integral piece with the main housing 1, and a root portion of the elastic arc-shaped barrier strip 42 is fixed to either the middle partition plate 4 or the main housing 1 outside the wiring groove 21. Typically, two arc-shaped barrier strips 42 are disposed.

A method for using the electrical outlet terminal configuration with a plurality of wiring points of the present disclosure includes the following steps: By rotating the screw 62, the cap 61 of the screw 62 is moved upward or downward, and the lower clamping plate 64 is driven to move upward or downward, which enables clamping or loosening of the inserted wire; and since wires can be inserted into both the wiring holes 5 and the notch slots 36, more wires can be conductively connected to achieve connection of more electrical loads.

Embodiment 2 is basically identical to Embodiment 1 in the present disclosure, with the only difference lying in that in this embodiment, three terminals are disposed below each of the protective covers, and three wiring holes 5 are disposed below each of the terminals.

The above descriptions are only the preferred embodiments of the present disclosure, and should not be construed as a limitation to the present disclosure in any form. Although the present disclosure has been disclosed through the preferred embodiments, such disclosure is not intended to limit the present disclosure. Any person skilled in the art may, without departing from the technical solution scope of the present disclosure, make numerous alterations or modifications to the disclosed technical contents to obtain equivalent embodiments of equivalent variations. Any simple change, equivalent variation, or modification, made to the above embodiments according to the technical essence of the present disclosure without departing from the contents of the technical solutions of the present disclosure, should fall within the protection scope of the technical solutions of the present disclosure.

What is claimed is:

1. An electrical outlet terminal configuration with a plurality of wiring points, comprising a main housing provided with terminals, wherein the main housing is provided with mounting grooves recessed inward from an outer surface of the main housing, and the terminals are mounted within the mounting grooves; a flippable protective cover is disposed for each of the mounting grooves, an upper portion of the protective cover is pivotally connected to the main housing, a mutually engageable force-releasable snap-fit mechanism is disposed for the protective cover and the main housing, and the snap-fit mechanism is engaged when the protective cover is closed to cover the mounting groove; and wherein a middle partition plate is disposed below the protective cover to partition a space into a plurality of terminals, a lower side end of the main housing is provided with wiring holes aligned with the terminals, each of the terminals is aligned downward with a plurality of the wiring holes, a wire is inserted into the terminal via one of the wiring holes, and the wire is clamped and conductively connected by a first conductive clamping mechanism of the terminal.

2. The electrical outlet terminal configuration with a plurality of wiring points according to claim 1, wherein each of the protective covers comprises a panel, side edges, and a lower edge, wherein the side edges and the lower edge are perpendicular to the panel, the lower edge is provided with notch slots, two of the notch slots are disposed below each terminal, two prongs of a U-shaped blade are inserted into the terminal through the corresponding notch slots, and the prongs are clamped and conductively connected by a second conductive clamping mechanism of the terminal.

3. The electrical outlet terminal configuration with a plurality of wiring points according to claim 1, wherein the space within each of the protective covers is partitioned by a middle partition plate into two terminals, and each of the terminals comprises a screw with a cap, a wiring end plate, and a lower clamping plate; each of the mounting grooves is partitioned into wiring grooves, the wiring end plate is mounted on stepped surfaces of each of the wiring grooves, the lower clamping plate is positioned within the wiring groove and beneath the wiring end plate, and the screw extends through threaded holes of the wiring end plate and the lower clamping plate to form a threaded connection fit; the first conductive clamping mechanism comprises the screw, the wiring end plate, and the lower clamping plate, and side walls of the wiring groove restrict rotation of the wiring end plate and the lower clamping plate in a blocking manner; each of the terminals corresponds to two of the wiring holes, and the wiring holes directly face the space between the lower clamping plate and the wiring end plate; and after a wire is inserted through one wiring hole into the space between the lower clamping plate and the wiring end plate, the screw is rotated to cause the lower clamping plate to ascend and clamp the wire against the wiring end plate, thereby establishing a conductive connection.

4. The electrical outlet terminal configuration with a plurality of wiring points according to claim 3, wherein two of the wiring holes are disposed below each of the terminals.

5. The electrical outlet terminal configuration with a plurality of wiring points according to claim 2, wherein each of the terminals comprises a screw with a cap, a wiring end plate, and a lower clamping plate, and each of the terminals corresponds to two of the notch slots; the mounting groove is partitioned into wiring grooves, the wiring end plate is mounted on stepped surfaces of each of the wiring grooves, the lower clamping plate is positioned within the wiring groove and beneath the wiring end plate, and the screw extends through threaded holes of the wiring end plate and the lower clamping plate to form a threaded connection fit; the screw and the wiring end plate constitute a second conductive clamping mechanism, and side walls of the wiring groove restrict rotation of the wiring end plate and the lower clamping plate in a blocking manner; and after a U-shaped blade is inserted through the notch slots into the space between the cap and the wiring end plate, the screw is rotated to cause the cap to descend and clamp the U-shaped blade against the wiring end plate, thereby establishing a conductive connection.

6. The electrical outlet terminal configuration with a plurality of wiring points according to claim 5, wherein an inner side of the lower edge of the protective cover is provided with a triangular latching tooth, and a lower side of the middle partition plate of the main housing is provided with a latching groove matching the latching tooth; and when the protective cover is flipped down and secured onto the terminal, the latching tooth is snap-fitted into the latching groove along a triangular mating surface.

7. The electrical outlet terminal configuration with a plurality of wiring points according to claim 6, wherein a lower partition plate of each of the wiring grooves extends laterally to form an elastic arc-shaped barrier strip, and a root portion of the elastic arc-shaped barrier strip is fixed to either the middle partition plate or the main housing outside the wiring groove.

8. The electrical outlet terminal configuration with a plurality of wiring points according to claim 5, wherein an inner wall of each of the protective covers is provided with circular lateral recesses matching the terminals at positions corresponding to the terminals.

9. The electrical outlet terminal configuration with a plurality of wiring points according to claim 7, wherein an inner wall of each of the protective covers is provided with circular lateral recesses matching the terminals at positions corresponding to the terminals.

10. The electrical outlet terminal configuration with a plurality of wiring points according to claim 5, wherein each of the protective covers is provided with pivot shafts on both sides, the main housing on both sides of each of the mounting grooves is provided with pivot connecting grooves, and the pivot shafts are inserted into the pivot connecting grooves.
